(19) United States
(12) Patent Application Publication
(10) Pub. No.: US 2004/0261644 A1
(43) Pub. Date: Dec. 30, 2004

(54) Medical patient labeling system and method

(76) Inventors: Thomas R. Stewart, Brentwood, TN (US); Brian D. Moyer, Brentwood, TN (US)

Correspondence Address: Jerad G. Seurer, Wyatt, Tarrant & Combs, LLP, Suite 800, 1715 Aaron Brenner Drive, Memphis, TN, 38120-4367, US

(21) Appl. No.: 10/899,283

(22) Filed: Jul. 26, 2004

Related U.S. Application Data
(62) Division of application No. 09/952,425, filed on Sep. 14, 2001.

(51) Int. Cl. B42D 15/00

(52) U.S. Cl. 101/483

(57) ABSTRACT

The present invention is directed to methods of using a medical label sheet. The medical label sheet generally has a number of labels including at least one chart label, at least one adult wristband label, and at least one child wristband label. In one method, medical information regarding a patient may be printed to the various labels of the medical label sheet. After the appropriate information has been printed to the labels, the chart label(s) may be removed from the medical label sheet and applied to any appropriate surface. Likewise, the adult wristband label(s) and/or child wristband label(s) may be removed from the medical label sheet and applied to one or more appropriate wristbands. In some embodiments, the medical label sheet may be inserted into an appropriate medical chart book (e.g., a ring binder) by employing one or more holes defined in the medical label sheet.

### CROSS-REFERENCE TO RELATED APPLICATION

This patent application is a division of pending U.S. patent application Ser. No. 09/952,425 entitled “Medical Patient Label System and Method” filed on Sep. 14, 2001.

A portion of this patent document contains material that may be subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

The present invention relates generally to medical patient identification and record keeping. More particularly, this invention pertains to the printing of adhesive labels for affixation to medical patient charts and patient identification wristbands.

Medical patient recordkeeping systems usually involve charts containing information relating to the treatment of the patient and personal identification systems such as medical patient wristbands worn by the medical patient to correlate the patient, the patient's records, and the patient's treatment. Providers of medical services have a strong interest in maintaining accurate medical patient information in the most efficient manner possible.

It is well known in the art of medical patient recordkeeping to make printed adhesive labels for affixation to a medical patient's medical charts. It is further well known to print wristbands for medical patients to wear for identification. The making of such chart and wristband labels has historically been done by hand. With the advent of computers, the making of chart labels became easier, especially where such chart labels could be printed on a single sheet of adhesive label paper on a computer printer. Today, medical patient chart labels are commonly printed in this manner, and, to ensure positive patient identification and reduce the risk of medical error with regard to treatment of patients, it is becoming necessary for the patient information on such labels to include machine-readable information such as a bar code for reference to the medical service provider's computer system records.

One of the more costly aspects of medical patient recordkeeping machinery has been that patient chart labels were printed separately from patient wristbands. Until recently, there was no convenient way to print chart labels and the ID wristband simultaneously. Although several methods and types of computer software have been developed for such simultaneous printing, there has been no efficient way to simultaneously print medical patient information on chart labels and wristband labels, the labels being on a single sheet of adhesive-backed paper.

Several attempts to solve the single-sheet problem involved the printing of the chart labels on one portion of the sheet, and the printing of information on a wristband on a second portion, where the entire wristband was incorporated into the second portion of the sheet. Two such methods, taught in U.S. Pat. Nos. 6,067,739 and 5,653,472, involved printing patient information on a label sheet in a single printer pass, where the label sheet was divided into a chart label section and a wristband section.

As described in the '739 and '472 patents, the chart label section of the printable sheet consisted of twenty standard sized medical chart labels. The wristband section of the sheet was made of a special multi-ply paper, with a single wristband forming the entire useful area of the wristband section. In addition to requiring a special multi-web paper construction, the wristband section only allowed for the printing of a single wristband per form, with the wristband having a fixed size pre-determined by the manufacturer in the die-cutting of the printable sheet. However, most hospitals need at least two sizes of wristbands, adult and pediatric. If the label sheet was pre-cut with an adult size wristband, the admitting clerk would have to separately create a pediatric wristband.

Moreover, because the prior art label sheet was not hole-punched, the label sheet could not be inserted in a medical patient's chart except in a loose-leaf fashion.

The systems used in the prior art also required a type of paper that was extremely specialized and expensive to procure. The methods were very inefficient in their use of space on the paper; the second portion consumed a substantial portion of the printable page, only a fraction of which was useable for the wristband. Moreover, in order to print the wristbands, these methods required wristbands that would not bear any adhesive against the patient's skin when worn, and the sizes of the wristbands involved were only sized to fit adult medical patients, not pediatric ones. Finally, the printable label sheets did not allow for fixed insertion of the sheets in a patient's medical chart book.

What is needed, then, is a method of efficiently creating a single sheet of adhesive-backed medical information labels for use with patient charts, as well as for identification wristbands, regardless of whether the patient is a child or an adult, and where the label sheet can be fixably inserted in a patient's medical chart book.

### SUMMARY OF THE INVENTION

The invention disclosed herein is a medical patient label sheet comprising a top sheet with a front surface of a printable material and a back surface having a patterned adhesive coating applied to the bottom surface. The top sheet is die-cut in a pattern to form a plurality of chart labels, at least one child-sized wristband label, and at least one adult-sized wristband label. A backing sheet having a release coating is removably attached to the back surface of the label sheet, so that the labels can be removed from the label sheet after being printed upon.

In further refinements to the invention, any or all of which may or may not be employed by those practicing the invention, the medical patient label sheet is of a standard size paper; the label sheet is laser-printable; the label sheet is punched with holes sufficient to allow the label sheet to be inserted in a medical chart book; the chart and wristband labels are printed with information relating to a single patient; and at least a part of the information printed upon the chart labels is bar-coded information.

Accordingly, it is an object of the invention to provide a sheet of chart labels relating to a medical patient for affixation to medical patient charts and patient wristbands.

It is a further object of the invention to provide a sheet of medical patient chart labels where the sheet is printable in a single printer pass through a printer, such as a laser printer.

It is a further object of the invention to make a sheet of medical patient chart labels that is insertable into any of a variety of medical chart books.

In addition to the foregoing, further objects, features, and advantages of the present invention should become more readily apparent to those skilled in the art upon a reading of the following detailed description in conjunction with the drawings, wherein there are shown and described illustrated embodiments of the invention.

### BRIEF DESCRIPTION OF THE DRAWINGS

FIG. 1 is a plan view of the label sheet of the invention before being printed upon in the practice of the invention.

FIG. 2 is a plan view of an adult patient wristband with the bar-coded medical patient label of the invention affixed to the wristband.

FIG. 3 is a plan view of an adult patient wristband with the medical patient label of the invention affixed to the wristband.

FIG. 4 is a plan view of a child patient wristband with the medical patient label of the invention affixed to the wristband.

FIG. 5 is a plan view of the label sheet of the invention after being printed upon in the practice of the invention.

### DESCRIPTION OF THE PREFERRED EMBODIMENTS

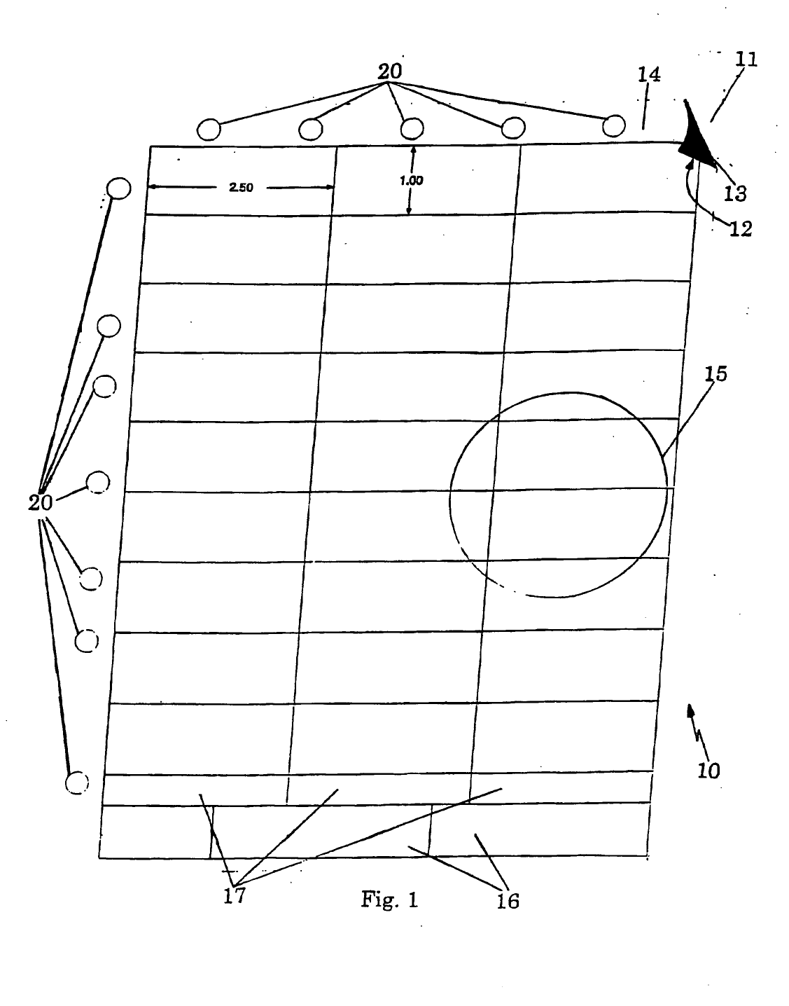

Referring to FIG. 1, a preferred embodiment of the medical patient label sheet 10 of the invention is shown. Label sheet 10 is a two-ply sheet with a bottom ply 11 and a top ply 12.

Top ply 12 has a back 13 that has a patterned adhesive coating applied; in other words, back 13 does not merely have an adhesive coating applied to the entire surface of back 13. A suggested adhesive pattern of the adhesive specifies that no adhesive comes within ⅛″ of any edge, including the four edges of label sheet 10 and any of the plurality of holes 20. Such a pattern would be desirable to prevent the adhesive from melting and fugitive “adhesive ooze” from being deposited in a high-temperature laser printer as the label sheet 10 is being imprinted. Top ply 12 also has a front 14 that is printable, preferably by a laser printer. Bottom ply 11 (also generally referred to as a “liner”) is coated with a release to provide a peel strength offering the greatest ease of use for the end user, while at the same time ensuring that labels will not pre-dispense in the printer. Ideally, label sheet 10 is made of a standard-size (8.5″×11″) paper. A typical peel strength is 18-20 grams. A plurality of holes 20 are made in the perimeter of label sheet 10 so that label sheet 10 may be inserted and fastened in any of a number of medical chart books in a conventional way.

Further referring to FIG. 1, top ply 12 is die-cut to define a plurality of chart labels 15 and a plurality of wristband labels 16. Nine (9) rows of three (3) columns of labels are die-cut in top ply 12. Chart labels 15 are made of a size to fit standard medical charts and record books. A typical size for chart labels 15 is 2.5″×1″. The plurality of wristband labels 16 may further be separated into child-sized labels 17 and adult-sized labels 18. Child-sized labels 17 are typically 2.5″×0.4375″ in size, and in a preferred embodiment there are three (3) child-sized labels 17 per label sheet 10. Adult-sized labels 18 are typically 3″×0.75″, and there are normally two such adult-sized labels 18 per label sheet 10. It should be noted that while the terms “child-sized” and “adult-sized” are used herein, the terms are merely used to indicate the relative sizes of the labels. Adult-sized labels are equal in length and approximately twice the width of child-sized labels. In addition to the obvious increase in printable area of the adult-sized labels over the child-sized labels, adult-sized labels are able to be larger due to the larger-sized wristbands that are used on the arms or ankles of adults. Therefore, regardless of the terminology used, the size of wristband label to be used depends upon the type of medical patient wristband to be used.

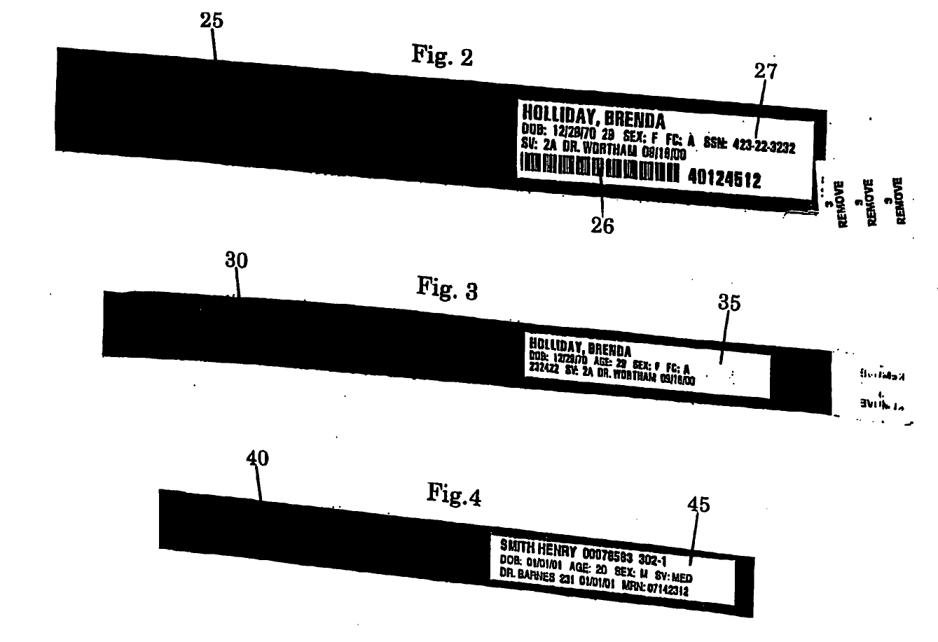

Further referring to FIG. 1, top ply 12 is die-cut to define two (2) adult-sized wristband labels 16 and three (3) child-sized wristband labels 17. Referring to FIG. 2, a conventional adult medical patient wristband 50 is shown. Adult medical patient wristband 50 is a common, standard plastic wristband as can be purchased from a manufacturer such as Products International or Precision Dynamics. Most manufacturers of wristbands make the wristbands in a few standard sizes, and FIGS. 2-4 display several of the standard sizes. The dimensions of the wristband are not critical, so long as the label to be applied to the wristband does not dimensionally exceed the boundaries of the wristband's width and length. In FIG. 2, medical patient informational label 55 is shown as applied to wristband 50, after label 55 is printed in the single printer pass referred to herein. In a preferred embodiment, an area of bar coding 51 may be added to medical patient informational label 55 for compatibility with an information system that may be used by a medical service provider that employs label sheet 10. While area of bar coding 51 is not elemental to the manufacturing of label sheet 10, bar coding may be added to label sheet 10 in the practice of the invention as a convenient means of printing an amount of machine-readable information onto the label sheet. In this manner, label sheet 10 may be manufactured by a manufacturing entity, and the area of bar-coding 51 may be added by an end user entity, and the manufacturing entity and the bar-coding entity may be totally separate entities.

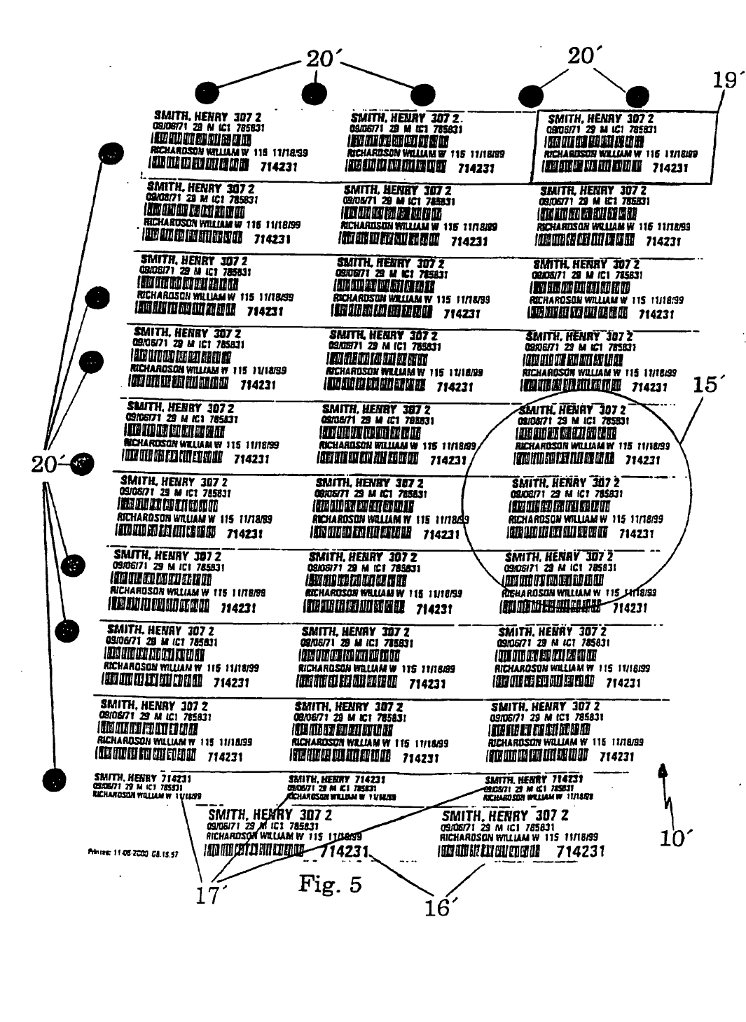

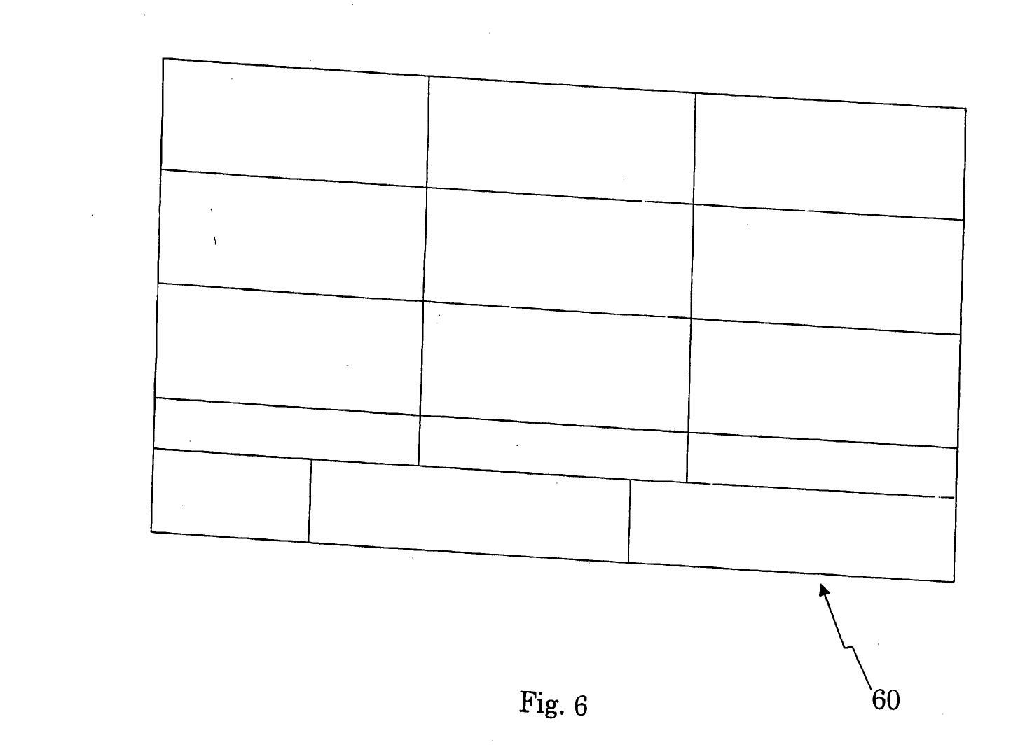

Referring to FIGS. 3 and 4, any of child-sized labels 17, once printed upon, may be applied to a standard child medical patient plastic wristband 70 as shown in FIG. 4, or to a scaled-down adult medical patient wristband 60 as shown in FIG. 3. Again, although the terms “child-sized” and “adult-sized” are used with respect to the labels, the terms are merely indicative of size of the wristband to which the labels will be applied. Adult-sized labels may be used on child wristbands (and vice-versa) if the wristband is of sufficient surface area to support the label. For example, a key distinction between wristband 50 and wristband 60 is that wristband 50 can support a larger label than wristband 60. With the larger surface, an area of bar-coding 51 may be added to label 55 for use with computerized patient information systems.

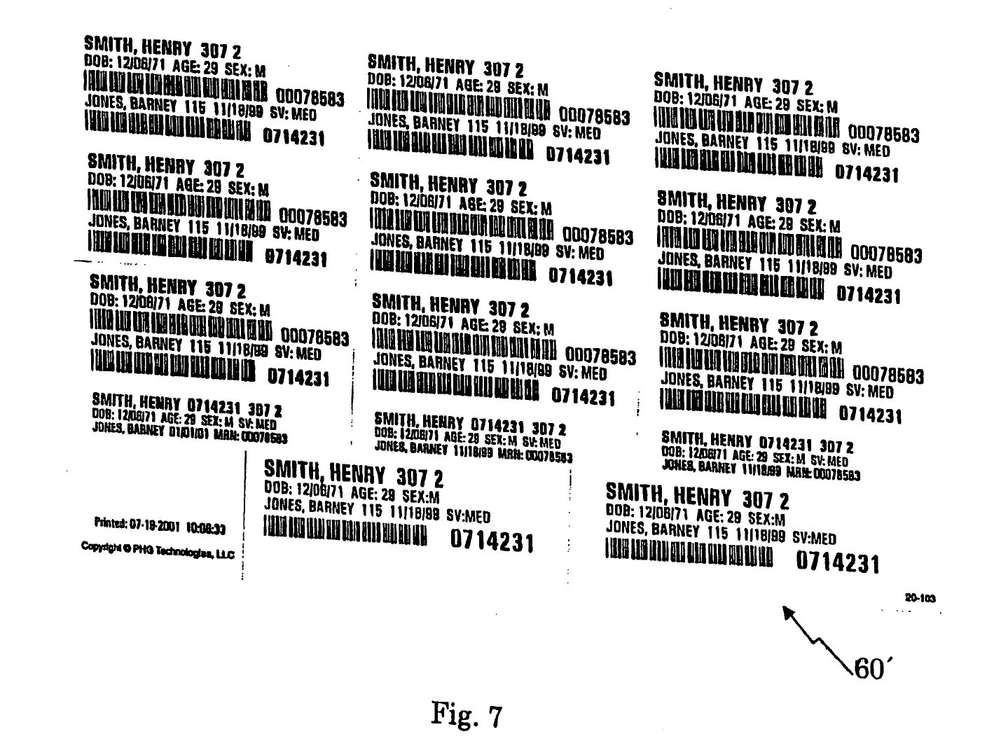

Referring to FIG. 5, a label sheet 70 has been printed as an exemplar of the invention and the product of the method of the invention. Label sheet 70 is identical to label sheet 10, with the exception that, in the practice of the invention, label sheet 70 has been printed with medical patient information 71. Each label on label sheet 70 has been printed with the same patient's information, and label sheet 70 has been printed in a single pass through a laser printer. Having been thus printed, label sheet 70 may be inserted in a patient's medical chart via holes 80. Chart labels 75 may be applied to any surface that the medical service provider may require. Wristband labels 76, separated into child-sized wristband labels 77 and adult-sized wristband labels 78, may be applied to an appropriate medical patient wristband as needed.

Printing a sheet of labels on label sheet 10 is performed by inserting label sheet in a printer such as a laser printer and printing a medical patient's information on each of the labels on label sheet 10 in a single printer pass. Again, the creation of label sheet 10 and the printing of information on label sheet 10 may occur thousands of miles apart and at the hands of different people. Label sheet 10 will then be inserted into the patient's medical chart and the pre-printed removable or peel-off labels will be used for recordkeeping related to the patient's care. Further patient labels would not be required to be printed until label sheet 10 was exhausted of the labels of interest during the time the patient's care is being provided. Such a “single-pass” printing feature optimizes patient recordkeeping to the extent that a new label will not be required to be printed each time a new chart or wristband label needs to be made.

Alternatively, the invention could be described as a method of making adhesive labels for medical patients, comprising the steps of printing information relating to at least one medical patient on a label sheet of adhesive-backed printable paper, the information being printed on a first portion of the label sheet having a plurality of medical chart labels of a size for affixing to the patient's record chart; and printing the information on a second portion of the label sheet having labels of a size for affixing to a wristband to be worn by the medical patient. In a preferred embodiment, the labels are laser-printable and the wristband labels are sized to fit adult and child sized patient wristbands. The patient information may also include bar coding for computerized patient information systems.

Finally, the invention may be described as a method of administering medical patient information. The method is performed in a medical care provider environment such as a hospital or clinic, and has the following steps: (a)admitting a medical patient to the medical care provider; (b)collecting patient information from the medical patient; (c)storing the patient information in a medical patient information storage system; (d)inserting a medical patient label sheet in a computer printer, the medical patient label sheet having a plurality of medical patient adhesive chart labels and a plurality of medical patient adhesive wristband labels; (e)printing at least a portion of the patient information on the chart labels; and (f)printing at least a portion of the patient information on the wristband labels.

Thus, although there have been described particular embodiments of the present invention of a new and useful Medical Patient Labeling System and Method, it is not intended that the description of such embodiments be construed as limitations upon the scope of this invention except as set forth in the following claims.

What is claimed is:

1. A method of using a medical label sheet, the method comprising the steps of:
removing, from a medical label sheet comprising a first wristband label of a first size and a second wristband label of a second size smaller than said first size, at least one of said first and second wristband labels; and
applying said at least one of said first and second wristband labels to a wristband.

2. A method, as claimed in claim 1, wherein:
said removing step comprises:
removing said first wristband label from said medical label sheet; and
removing said second wristband label from said medical label sheet; and
said applying step comprises:
applying said first wristband label to a first wristband; and
applying said second wristband label to a second wristband.

3. A method, as claimed in claim 2, wherein:
said first wristband is larger than said second wristband.

4. A method, as claimed in claim 1, wherein:
said medical label sheet comprises a third label of a third size greater than said first and second sizes, wherein said third label is disposed between a top edge of said medical label sheet and said second wristband label, and wherein said second wristband label is disposed between said first wristband label and said third label.

5. A method, as claimed in claim 1, further comprising:
printing patient information on at least one of said first and second wristband labels prior to said removing and applying steps.

6. A method, as claimed in claim 5, wherein:
said printing step comprises printing bar-coded information on at least one of said first and second wristband labels.

7. A method, as claimed in claim 5, wherein:
said printing step comprises passing said medical label sheet through a printer only a single time.

8. A method, as claimed in claim 1, further comprising:
inserting said medical label sheet into a medical chart book, wherein said inserting step comprises employing a plurality of holes defined in said medical label sheet.

9. A method of using a medical label sheet, the method comprising the steps of:
removing a chart label from a medical label sheet, wherein said medical label sheet comprises:
at least one said chart label;
an adult wristband label of a first size; and
a child wristband label of a second size smaller than said first size;
applying said chart label to a medical record or medical chart book;
removing at least one of said adult wristband label and said child wristband label from said medical label sheet; and
applying said at least one of said adult wristband label and said child wristband label to a first wristband.

10. A method, as claimed in claim 9, wherein:
said removing step comprises removing said adult wristband label from said medical label sheet; and
said applying step comprises applying said adult wristband label to said first wristband.

11. A method, as claimed in claim 10, wherein:
said removing said adult wristband label step comprises removing said adult wristband label from a first location of said medical label sheet, wherein said first location is disposed between a bottom edge of said medical label sheet and said child wristband label.

12. A method, as claimed in claim 10, wherein:
said removing step comprises removing said child wristband label from said medical label sheet; and
said applying step comprises applying said child wristband label to a second wristband, wherein said first wristband is larger than said second wristband.

13. A method, as claimed in claim 9, wherein:
said removing step comprises removing said child wristband label from said medical label sheet; and
said applying step comprises applying said child wristband label to said first wristband.

14. A method, as claimed in claim 13, wherein:
said removing said child wristband label step comprises removing said child wristband label from a first location of said medical label sheet, wherein said first location is disposed between a top edge of said medical label sheet and said adult wristband label.

15. A method, as claimed in claim 9, further comprising:
printing patient information on at least one of said chart label, said adult wristband label, and said child wristband label prior to said removing a chart label step, said applying said chart label step, said removing at least one step, and said applying said at least one step.

16. A method, as claimed in claim 15, wherein:
said printing step comprises printing bar-coded information on at least one of said chart label, said adult wristband label, and said child wristband label.

17. A method, as claimed in claim 9, further comprising:
inserting said medical label sheet into a medical chart book, wherein said inserting step comprises employing a plurality of holes defined in said medical label sheet.

18. A method of using a medical label sheet, the method comprising the steps of:
printing patient information to a plurality of labels of said medical label sheet, said plurality of labels comprising:
a chart label of a first size;
an adult wristband label of a second size smaller than said first size, wherein said adult wristband label is disposed between said chart label and a bottom edge of said medical label sheet; and
a child wristband label of a third size smaller than said second size, wherein said child wristband label is disposed between said chart label and said adult wristband label;
removing at least one of said adult wristband label and said child wristband label from said medical label sheet; and
applying said at least one of said adult wristband label and said child wristband label to a wristband.

19. A method, as claimed in claim 18, further comprising:
inserting said medical label sheet into a medical chart book, wherein said inserting step comprises employing a plurality of holes defined in said medical label sheet.

20. A method, as claimed in claim 19, wherein:
said printing step comprises printing bar-coded information on at least one of said adult wristband label and said child wristband label.
